(19) United States
(12) Patent Application Publication
(10) Pub. No.: US 2011/0143299 A1
(43) Pub. Date: Jun. 16, 2011

(54) Method for Removing an Orthodontic Bracket from the Surface of a Tooth

(76) Inventor: Rolf FOERSTER, Pforzheim (DE)

(21) Appl. No.: 12/964,355

(22) Filed: Dec. 9, 2010

(30) Foreign Application Priority Data
Dec. 11, 2009 (DE) 10 2009 058 246.0

(51) Int. Cl. A61C 7/04

(52) U.S. Cl. 433/4

(57) ABSTRACT

The invention relates to a method and pliers for removing an orthodontic bracket from the surface of a tooth.

An orthodontic bracket typically comprises a base, an occlusal wall extending away from the base and comprising at least one occlusal ligature wing, a gingival wall extending away from the base and comprising at least one gingival ligature wing, and a channel which extends continuously between the occlusal wall and the gingival wall in the mesial-to-distal direction. This channel is also referred to as a slot. It is used to accommodate an archwire for transferring forces and torques to the tooth via the bracket to correct the position of a tooth. For this purpose, the bracket is bonded via the base thereof to the surface of the tooth. Once the tooth position has been corrected, the bracket must be removed from the tooth. It is known to use specially designed pliers for this purpose.

The pliers known from U.S. Pat. No. 3,986,265 comprise two jaws having projections which face one another, taper, and terminate in an engagement edge. The engagement edges are designed as a type of cutting lip. When the pliers are closed, the two cutting lips come into contact with one another along the lengths thereof. To remove a bracket from the surface of a tooth, the pliers are placed via the two engagement edges thereof against the occlusal and the gingival side of the bracket i.e. in a manner such that the engagement edges extend into the gap between the base of the bracket and the surface of the tooth. Next, the jaws are pressed toward one another so that they enter the gap between the base of the bracket and the surface of the tooth via the engagement edge and thereby progressively remove the bracket from the surface of the tooth. The detached bracket can drop into the patient's mouth and be accidentally swallowed by the patient.

To prevent this, it is known from U.S. Pat. No. 4,776,791 to place a shield on one of the two jaws, which protects the bracket after the pliers have been placed against the bracket, and subsequently catches the detached bracket. The disadvantage thereof is that the shield poses an obstacle to the removal of the bracket and obstructs the view of the bracket.

EP 1 790 309 A1 discloses a pair of pliers for removing a bracket from the surface of a tooth, the jaws of which do not have extensions that terminate in a point, but rather are rounded and cannot extend into the gap between the base of the bracket and the surface of the tooth to remove the bracket, but rather extend behind the ligature wing, into the space between the base and the ligature wings. To detach the bracket from the tooth, the pliers must pivot toward the bracket; this is accomplished in that one of the two jaws is also provided with a rounded support bearing which supports the jaw on the tooth surface and departs the extension of the jaw that reaches behind the ligature wing from the tooth surface when the pliers are closed. The aim is to thereby break through the adhesive located in the gap between the base of the bracket and the tooth. This procedure places high mechanical stress on the tooth, and the detached bracket can drop into the mouth and be accidentally swallowed.

EP 0 655 266 B1 discloses a method for removing ceramic orthodontic brackets, in the case of which the orthodontic bracket is broken into two parts using a pair of pliers. To accomplish this, a special bracket must be used that is modified such that it comprises a slot first slot accommodating an archwire and a second slot that extends transversely to the first and extends from the labial side transversely through the bracket to the base of the bracket. This second slot makes it possible to press the two sections of the bracket subdivided by the second slot toward one another until the base underneath the second slot breaks because the walls of the bracket are thinnest at this point. To implement this method, publication EP 0 655 266 B1 discloses a pair of pliers having jaws that act on the bracket from the distal direction and from the mesial direction. For the bracket to break, the jaws must act on the distal side and on the mesial side of the bracket only from above the base. Recesses are therefore provided in the jaws, into which a distal section and a mesial section of the bracket can be inserted from the labial side. The end of the recesses strikes the labial side of the bracket before the jaws reach the base of the bracket. Moreover, the two jaws are slotted starting at the ends thereof, thereby enabling them to extend beyond an archwire disposed in the slot in the bracket. Thus, the archwire need not be removed in order to detach the bracket. This makes it possible for the broken bracket to remain hanging on the archwire after removal if it is secured on the archwire by a ligature. Nevertheless, there is still a risk of the broken bracket pieces dropping into the mouth, because the bracket, which has been broken into two smaller pieces, is not necessarily retained on the archwire by the ligature. Ideally, both pieces of the broken bracket should become detached from the surface of the tooth. This cannot be ensured, however. Instead, there is a risk that, when the bracket is broken, only one of the two pieces has detached from the tooth surface and the other piece must then be removed from the surface of the tooth using another pair of pliers and in a separate working step, thereby rendering the removal procedure difficult and time-consuming.

The problem to be solved by the present invention is that of providing a method that is suitable in particular for removing a ceramic bracket, which does not have the above-described disadvantages and does not require that the bracket be modified.

### SUMMARY OF THE INVENTION

This problem is solved by a method for removing an orthodontic bracket comprising a base, an occlusal wall extending away from the base and comprising at least one occlusal ligature wing, a gingival wall comprising at least one gingival ligature wing and a channel which extends continuously between the occlusal wall and the gingival wall in the mesial-to-distal direction, from the surface of a tooth by placing a pair of pliers—which comprise two diametrically opposed jaws, at least one of which has an extension on the end thereof which faces the opposite jaw and comprises an engagement edge directed toward the opposite jaw, the extension tapering toward the engagement edge thereof—at two diametrically opposed sides of the bracket in a manner such that the at least one engagement edge extends into the gap between the tooth surface and the base of the bracket facing the tooth surface, and reducing the distance between the two jaws of the pliers, thereby enabling the at least one tapering extension to enter the gap and thereby remove the base of the bracket from the surface of the tooth.

A pair of pliers that is particularly suited for and adapted to the method of removing an orthodontic bracket which comprises a base, an occlusal wall extending away from the base and comprising at least one occlusal ligature wing, a gingival wall comprising at least one gingival ligature wing and a channel which extends continuously between the occlusal wall and the gingival wall in the mesial-to-distal direction, and which accommodates an archwire which extends through the channel and beyond the two ends thereof from the surface of a tooth comprises two diametrically opposed jaws which are joined to one another by a joint and at least one of which has an extension at the end thereof which faces the opposite jaw and comprises an engagement edge directed toward the opposite jaw, the extension tapering toward the engagement edge thereof.

Advantageous developments of the invention are the subject matter of the dependent claims.

According to the invention, an orthodontic bracket comprising a base, an occlusal wall extending away from the base and comprising at least one occlusal ligature wing, a gingival wall extending away from the base and comprising at least one gingival ligature wing, and a channel which extends continuously between the occlusal wall and the gingival wall in the mesial-to-distal direction is removed from the surface of a tooth by placing a pair of pliers—which comprise two diametrically opposed jaws, at least one of which has an extension facing the opposite jaw and comprising an engagement edge directed toward the opposite jaw, the extension tapering toward the engagement edge thereof—at two diametrically opposed sides of the bracket, i.e. at the mesial side thereof and at the distal side thereof, using the two jaws thereof in a manner such that the at least one engagement edge extends into the gap between the tooth surface and the base of the bracket facing the tooth surface, and by then reducing the distance between the two jaws of the pliers, thereby enabling the at least one tapering extension to enter the gap and thereby remove the base of the bracket from the surface of the tooth. The two jaws of the pliers each comprise a slot for this purpose. The two slots are aligned with one another, and a plane that is aligned with the two slots intersects the engagement edge of the at least one tapering extension at a right angle.

This has substantial advantages:
The method, in combination with the special pliers, is suitable for removing the bracket at a point in time at which the orthodontic archwire, which extends through one or more brackets for the purpose of correcting a position of a tooth and is typically anchored via the ends thereof on molars, has not yet been removed, and instead still extends through the slot of the bracket to be removed. The pliers can be placed via the two jaws thereof against the distal side and the mesial side of the base of the bracket in a manner such that the at least one tapering extension thereof extends into the gap between the surface of the tooth and the base of the bracket. This is made possible by the slots in the jaws of the bracket, by way of which the two jaws can be placed on the orthodontic archwire which is still anchored in the mouth.
Given that the at least one extension of the pliers ends in a point and terminates in an engagement edge which can be used to place the pliers against the bracket in a manner such that the engagement edge extends into the gap between the surface of the tooth and the base of the bracket, it is possible to remove the bracket from the tooth in a gentle manner i.e. in a manner that is gentle on the tooth and the bracket. In particular, ceramic brackets—which are particularly prone to breaking given their brittleness—can be removed from the tooth surface without breaking. This has the advantage of enabling the bracket to be reused, and of preventing fragments from dropping into the mouth and possibly being swallowed.
The at least one extension disposed at the end of a jaw removes the bracket by being pressed into the gap between the tooth surface and the base of the bracket in the manner of a wedge. The bracket is thereby removed progressively and without a peak load being applied to the tooth surface and the side of the bracket base facing the tooth surface, and therefore in a manner that is particularly gentle on the tooth.
The method is suitable for use with all types of brackets, in particular self-ligating brackets. The latter are brackets in which the archwire lying in the slot or channel of the bracket is secured by a sliding element or a clip that bridges the slot and is a component of the bracket. Self-ligating brackets that are removed from the tooth remain hanging on the orthodontic archwire if the latter has already been detached from the anchoring thereof on molars.
If the aim is to remove brackets using the pliers according to the invention when an orthodontic archwire is still present in the slot, the two jaws of the pliers are placed against the bracket in a manner such that the slots provided in the jaws point into the slot or channel provided in the bracket. If the orthodontic archwire has already been removed, the slots in the jaws of the pliers do not necessarily have to point into the slot provided in the bracket, although it is preferable in order to prevent asymmetrical loads from being placed on the bracket if possible during the removal procedure. Preferably, however, the bracket is removed from the tooth while an archwire anchored in the mouth still extends through the slot in the bracket. The bracket can thereby be prevented from accidentally dropping into the patient's mouth.

Advantageously, a pair of pliers is used in which the two slots in the jaws are at least as wide as the slot provided in the bracket. It is then possible to use one pair of pliers for every application. The width of the slot in the jaws is currently typically 0.5 mm, thereby enabling it to accommodate archwires having a width or diameter up to 0.5 mm. Preferably, the slots in the jaws of the pliers are wider than the slot in the bracket. If so, the jaws of the pliers can be easily placed against the mesial side and the distal side of the bracket, and therefore on the archwire if the bracket is angled, and so the mesial side and the distal side of the bracket extend toward the longitudinal direction of the slot in the bracket at an angle that differs from 90°. The slots in the jaws are preferably 1 mm wide.

Preferably, a pair of pliers is used, the at least one extension of which is wedge-shaped. Particularly advantageously, the wedge surfaces have a contour that correspond to the typical contour of the surface of the tooth and the surface of the base of the bracket facing the tooth surface, on which it is intended to act.

In principle, a pair of pliers could be used, in the case of which the at least one extension is provided on only one of the two jaws. In that case, the removal procedure progresses continuously from the one distal or mesial side of the bracket. Preferably, however, a pair of pliers is used in which the extensions are provided on both jaws, preferably symmetrically to one another. This simplifies and accelerates the removal procedure.

The engagement edges of the pliers should preferably not come in contact with one another when the pliers are closed. This is advantageous in particular when ceramic brackets are removed, because removal can occur abruptly in that case. If this occurs, the engagement edges can strike one another abruptly if no countermeasures are taken to prevent this. An adjustable stop that acts between the jaws or between the handles of the pliers, which stop can especially be formed by an adjusting screw, can prevent the engagement edges from striking one another and wear prematurely.

The engagement edges each form the vertex of a wedge shaped extension. An engagement edge can be formed by a small radius or a small plane surface at the tip of the wedge shaped extension. The radius of the edge or the width of the small plane surface, respectively, is preferably in the range of 0.1 mm to 0.2 mm. Therefore, the engagement edges can enter very well into the gap between the lingual side of the base of the bracket and the surface of the tooth when the pliers are closed. At the same time the engagement edges are sufficiently robust and wear resistant. At least the wedge shaped extensions with the engagement edges, preferably the whole pliers, consist of a surgical steel, preferably of steel with the number 1.4197 or 1.4021 according to the European standard EN10027. Such a surgical steel has the advantage that the pliers, especially in the area of the engagement edges, have the necessary hardness.

### BRIEF DESCRIPTION OF THE DRAWINGS

An embodiment of the invention is presented in the attached drawings.

FIG. 1 shows a self-ligating bracket having a sliding element in the open position thereof, in an oblique view of the labial side,

FIG. 2 shows the bracket depicted in FIG. 1 in an oblique view of the lingual side of the base of the bracket,

FIG. 3 shows the bracket depicted in FIG. 1 in an oblique view as in FIG. 1, but with the sliding element in the closed position thereof,

FIG. 4 shows a pair of pliers according to the invention, in a side view in the direction parallel with the axis of the joint of the pliers,

FIG. 5 shows detail X depicted in FIG. 4, in an enlarged view,

FIG. 6 shows the pliers depicted in FIG. 4, in a side view rotated by 90°,

FIG. 7 shows detail Y depicted in FIG. 6, in an enlarged view,

FIG. 8 shows the pliers engaged in a bracket, and

FIG. 9 shows detail Z depicted in FIG. 8, in an enlarged view.

### DETAILED DESCRIPTION

The bracket depicted in FIGS. 1 to 3 has a curved base 1, the curvature of which traces the front side of a tooth. On underside 2 of base 1, which forms the lingual side of the bracket, base 1 includes recesses 3 which are arranged in rows and have an undercut design. An adhesive can be applied to underside 2 to bond the bracket to a tooth. The adhesive interlocks undercut recesses 3 and ensures good adhesion. Recesses 3 and, therefore, the undercuts, are oriented in the same direction in each of the rows. From row to row, however, they alternate between an orientation in one direction and an orientation in the other direction. A push in the mesial-to-distal direction that acts on the bracket therefore results in the same adhesion as does a push in the distal-to-mesial direction; when a push occurs in the occlusal-gingival direction or in the gingival-occlusal direction, adhesion is high regardless of the pushing direction.

Base 1 passes over into a base 4 supporting a gingival wall 5 and an occlusal wall 6. Walls 5 and 6 extend parallel to one another and are separated by a channel 7 which extends continuously from distal to mesial in a straight line and is open in the labial direction.

A ligature wing 8 that extends in the gingival direction is provided on gingival wall 5. A ligature wing 9 that extends in the occlusal direction is provided on occlusal wall 6.

As an alternative, ligature wings 8 and 9 can each be subdivided into a pair of ligature wings.

Channel 7, which is also referred to as a slot, is used to receive an archwire 10 which is indicated in FIG. 1 using dashed lines, has a rectangular cross section in particular, and is not a component of the bracket. By tightening archwire 10, pressure can be exerted on base 11 of channel 7, and torque can be exerted on walls 6 and 5 of the bracket. For this purpose, the inner cross-section of channel 7 is substantially rectangular in design. In the present case, it is limited by base 11 of channel 7, and by gingival wall 5 and occlusal wall 6.

A labial recess 14 in gingival wall 5 and a labial recess 15 in occlusal wall 6 accommodate a primarily flat sliding element 13 having a rectangular outline. Recesses 14 and 15 have undercuts 16 which extend parallel to one another and to base 11 of channel 7, and which, together with base 17 of recess 15 and base 20 of recess 14, form a sliding guide for sliding element 13; undercuts 16 prevent sliding element 13 from falling out of the sliding guide in the labial direction. Recesses 14 and 15 are disposed in a common alignment. Recess 14 extends through gingival wall 5, while recess 15 terminates in occlusal wall 6 at a stop 18.

Sliding element 13 can be displaced in guide 15 to 17 in the gingival-occlusal direction, between an open position depicted in FIGS. 1 and 2 and a closed position depicted in FIG. 3. In the open position, channel 7 is open to full width from the labial direction. Front end 19 of sliding element 13 is preferably aligned with the surface of gingival wall 5 limiting channel 7, as shown in FIGS. 1 and 3. In the closed position, front end 19 of sliding element 13 strikes second stop 18 on occlusal wall 6, as shown in FIG. 3. In the closed position, sliding element 13 bridges channel 7, thereby preventing an archwire 10 extending therein from emerging from channel 7 in the labial direction.

A detailed description of this bracket is provided in DE 10 2006 053 215 B4.

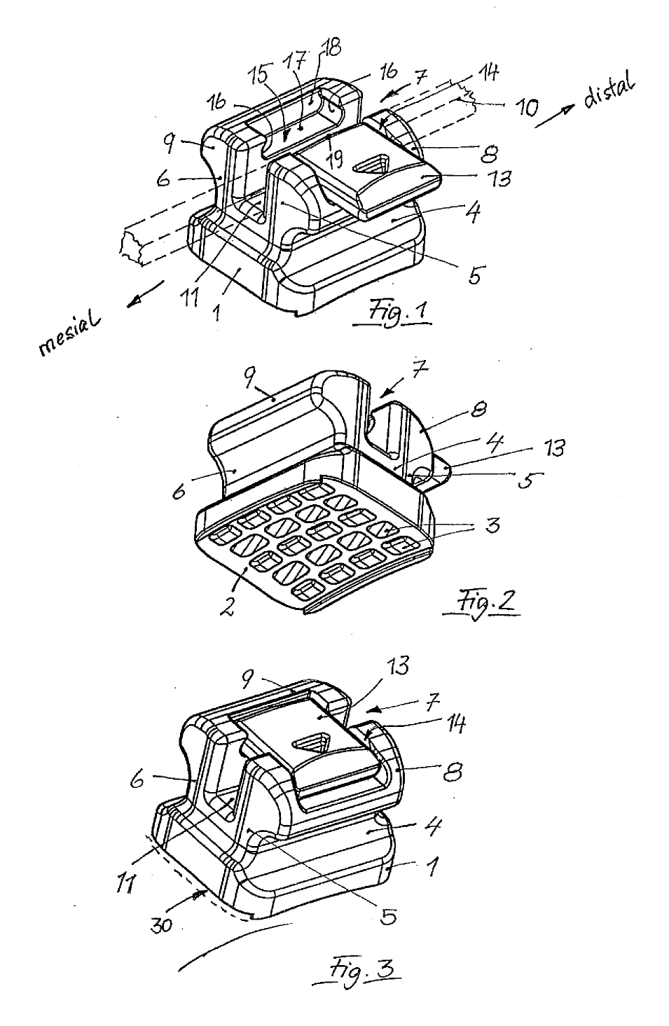

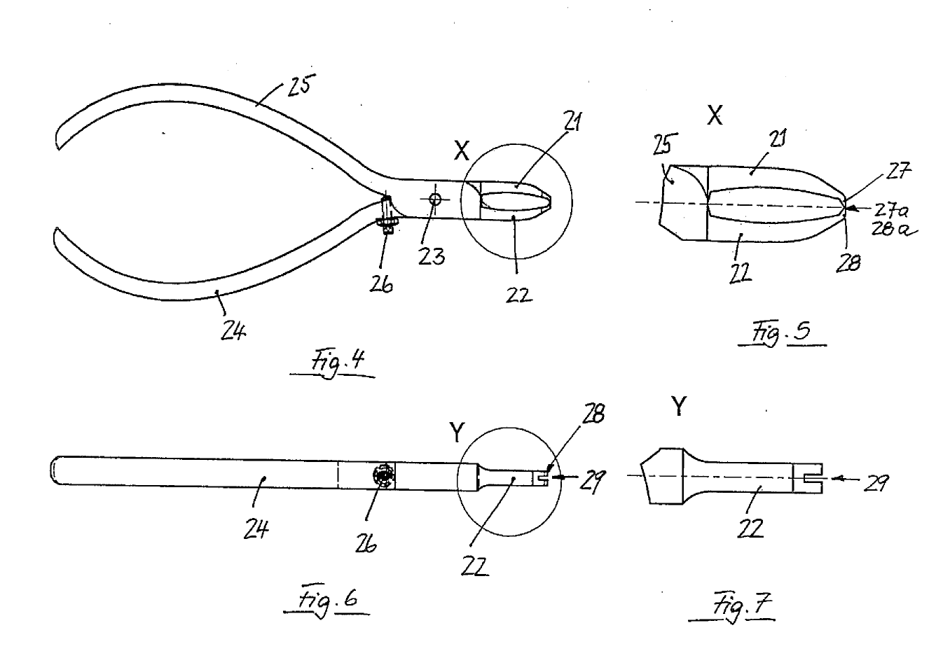

The pliers shown in FIGS. 4 to 7 comprise two substantially identical jaws 21 and 22 which are connected by a joint 23 and can pivot about the axis thereof. Jaw 21 transitions into a handle 24, and jaw 22 transitions into a handle 25. An adjusting screw 26 is screwed into a threaded hole in handle 24, the front end of which forms an adjustable stop for opposite handle 25. The closing motion of the pliers can be limited in a variable manner using adjusting screw 26.

On the front end of jaws 21 and 22 an extension 27 and 28, respectively, is provided, which taper toward the tips thereof, forming a wedge shape, and terminate in an engagement edge 27a, 28a which can be rounded with a small radius R and forms the vertex of wedge-shaped extension 27 and 28. The small radius R is preferably in the range between 0.05 mm and 0.15 mm. Engagement edges 27a, 28a of jaws 21 and 22 are oriented toward one another, although they do not come into contact with one another when the pliers are closed if adjusting screw 26 is set such that it impacts handle 25 before engagement edges 27a, 28a can come into contact with one another.

The surfaces of wedge-shaped extensions 27 and 28 on the outside of jaws 21 and 22 are disposed in a common plane, while the surfaces of wedge-shaped extensions 27 and 28 on the inside of jaws 21 and 22 form an acute angle with one another when the pliers are closed.

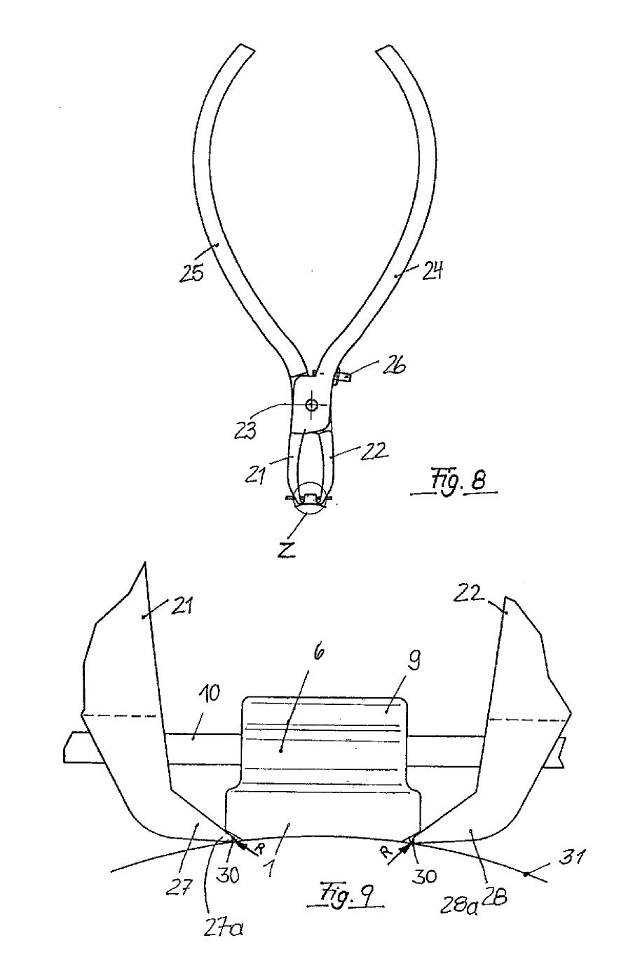

As shown in FIGS. 6 and 7, jaws 21 and 22 are slotted to a certain extent starting from the front end thereof. Slots 29 are disposed in a common alignment and have the same width. They are limited by two parallel surfaces which intersect the axis of joint 23 at a right angle. Slots 29 are at least 0.5 mm wide, and preferably approximately 1 mm wide. They extend through extensions 27 and 28 slightly further into adjoining section of jaws 21 and 22, as illustrated by comparing FIGS. 5 and 7.

Slots 29 are so deep that jaws 21 and 22 can be inserted via slots 29 over an archwire 10 lying in channel (slot) 7 of the bracket, and such that the front ends of jaws 21 and 22 can reach surface 31 of a tooth onto which the bracket (FIGS. 1 to 3) is bonded, thereby enabling engagement edges 27a, 28a to enter gap 30 between the lingual side of base 1 of the bracket and surface 31 of the tooth when the pliers are closed; see FIGS. 8 and 9. In this manner, the bracket is removed from surface 31 of the tooth and remains hanging on archwire 10, at least when sliding element 13 of the bracket is closed, thereby preventing it from dropping into the mouth.

### REFERENCE NUMERALS

1 base
4 base
5 gingival wall
6 occlusal wall
7 channel (slot) of the bracket
8 gingival ligature wing
9 occlusal ligature wing
10 archwire
11 base
13 sliding element
15 guide
16 undercuts/guide
17 base/guide
20 base
21 jaw
22 jaw
23 joint
24 handle
25 handle
26 adjusting screw
27 extension
27a engagement edge
28 extension
28a engagement edge
29 slots
30 gap
31 surface of a tooth

What is claimed is:

1. A method for removing an orthodontic bracket from the surface of the tooth, the bracket comprising a base, an occlusal wall extending away from the base and comprising at least one occlusal ligature wing, a gingival wall comprising at least one gingival ligature wing and a channel which extends continuously between the occlusal wall and the gingival wall in the mesial-to-distal direction, the method comprising:
placing a pair of pliers, which comprise two diametrically opposed jaws, at least one of which has an extension on the end thereof which faces the opposite jaw and comprises an engagement edge directed toward the opposite jaw, the extension tapering toward the engagement edge thereof at two diametrically opposed sides of the bracket in a manner such that the at least one engagement edge extends into the gap between the tooth surface and the base of the bracket facing the tooth surface, and
reducing the distance between the two jaws of the pliers, thereby enabling the at least one tapering extension to enter the gap and thereby remove the base of the bracket from the surface of the tooth,
wherein the two jaws of the pliers are placed on the bracket in the mesial and the distal direction and both comprise a slot for this purpose, the two slots being aligned with one another, and a plane, aligned with the two slots, intersects the at least one engagement edge at a right angle.

2. The method according to claim 1, wherein the bracket is removed from the tooth while an archwire still extends through the channel of the bracket.

3. The method according to claim 1, wherein a pair of pliers is used, in the case of which the two slots are at least as wide as the channel provided in the bracket.

4. The method according to claim 1, wherein a pair of pliers is used, the at least one extension of which is wedge-shaped.

5. The method according to claim 1, wherein a pair of pliers is used, the extensions of which are provided at both jaws.

6. The method according to claim 1, wherein a pair of pliers is used, in the case of which the two engagement edges are prevented from coming into contact with one another when the pliers are closed.

7. The method according to claim 1 applied to ceramic brackets.

8. The method according to claim 1 applied to self-ligating brackets.

9. A pair of pliers for removing an orthodontic bracket, which comprises a base, an occlusal wall extending away from the base and comprising at least one occlusal ligature wing, a gingival wall comprising at least one gingival ligature wing and a channel which extends continuously between the occlusal wall and the gingival wall in the mesial-to-distal direction, and which accommodates an archwire which extends through the channel and beyond the two ends thereof, from the surface of a tooth, the pliers comprising:
two diametrically opposed jaws joined to one another by a joint;
an extension disposed on an end of at least one of the jaws and facing an opposite jaw with an engagement edge directed toward the opposite jaw, the extension tapering toward the engagement edge, each jaw having an end channel aligned with one another and oriented in a plane intersecting an axis of the pliers joint at a right angle.

10. The pliers according to claim 9, wherein the two slots have the same width.

11. The pliers according to claim 9, wherein the two slots are at least 0.5 mm wide.

12. The pliers according to claim 9, wherein the two slots are 1 mm wide.

13. The pliers according to claim 9, wherein both jaws have an extension at the end thereof, and the two extensions are directed toward one another.

14. The pliers according to claim 13, wherein the engagement edges of the two extensions are prevented from coming into contact with one another when the pliers are closed by a stop that acts between the jaws or handles of the pliers.

15. The pliers according to claim 14, wherein the stop is formed by the adjusting screw.

16. The pliers according to claim 13, wherein the two jaws are identical or are designed as mirror images of each other.

17. The pliers according to claim 13, wherein the extensions are wedge-shaped in sections placed parallel to the channel.

18. The method according to claim 2, wherein a pair of pliers is used, in the case of which the two slots are at least as wide as the channel provided in the bracket, preferably being twice as wide as the channel.

19. The method according to claim 3, wherein the slots in the jaws of the pliers are twice as wide as the channel provided.
